(19) United States
(12) Patent Application Publication
(10) Pub. No.: US 2008/0295655 A1
(43) Pub. Date: Dec. 4, 2008

(54) Tension spanner

(76) Inventor: Chih-Ching Hsieh, Taichung City (TW)

Correspondence Address: Chih-Ching Hsieh, 235 Chung-Ho, Box 8-24, Taipei, TW

(21) Appl. No.: 11/807,608

(22) Filed: May 31, 2007

(51) Int. Cl. B25B 23/14; B25B 23/143

(52) U.S. Cl. 81/467; 73/862.23

(57) ABSTRACT

A tension spanner comprises a holding portion having an axial receiving hole at one end thereof; an outer periphery of the holding portion being formed with a plurality of textures for being held steadily; an upper periphery of the holding portion having a plurality of numbers for indicating the position in alignment; and a handle having an inner rod and an outer tube; one end of the inner rod being installed with an axial rolling ball; the outer tube having a receiving space; the inner rod in the outer tube can swing slightly in the receiving space of the outer tube; an outer side of the outer tube being formed with a scale; and an inner sleeve, an outer sleeve, an elastic body and a supporting post are received in the receiving space of the outer tube.

### FIELD OF THE INVENTION

The present invention relates to spanners, and particularly to a tension spanner which has less wear than the prior art spanner and thus has a longer lifetime.

### BACKGROUND OF THE INVENTION

Currently, there is a necessity for getting the tension of a spanner due to the requirement in operation so that the user can determine the required force applied to the screw means.

In one prior art, a tension spanner has a socket. The socket has a driving body, an action body, an elastic body, and a push block with a threaded hole. A surface of the action block is formed with a plurality of rollers. A screw rod is screwed to the screw hole of the push rod. The socket is formed with a guide hole corresponding to an indication of the push rod. The indication is received in the guide hole for confining the rotation of the push block. Two sides of the upper section of the guide hole are installed with tension indications of different units. A lower section of the screw rod is installed with a limiting unit. An inner wall of the socket is formed with a recess for receiving a ring so as to form as a stop seat. Thus the limiting unit of the screw can resist against the socket so that the push block exactly resists against the limiting unit. A lower section of the screw rod is installed with a driving section and a bottom surface thereof has a locking hole. An adjusting handle is installed at a lower outer side of the socket and the upper section of the indication exposes out of the upper end of the handle to match the tension indication at two sides. A lower side of the handle has a limiting groove which has a via hole for receiving the driving section. A locking unit of a stopper is installed.

However the prior art handle will generate a great wear to the socket and the balls will shift from normal position, even the balls will fall out. As a result, the spanner will destroy and the lifetime is reduced.

### SUMMARY OF THE INVENTION

Accordingly, the primary object of the present invention is to provide a tension spanner which has less wear than the prior art spanner and thus has a longer lifetime.

To achieve above objects, the present invention provides a tension spanner comprising: a holding portion having an axial receiving hole at one end thereof; an outer periphery of the holding portion being formed with a plurality of textures for being held steadily; an upper periphery of the holding portion having a plurality of numbers for indicating the position in alignment; a handle having an inner rod and an outer tube; one upper end of the inner rod having a head for locking to an object; the inner rod being formed with an inner through hole near the head; another end of the inner rod being installed with an axial rolling ball; the outer tube having a receiving space; one end of the outer tube being received in the receiving hole of the holding portion and another end thereof receiving the inner rod; an upper side of the outer tube having an outer through hole; by using a retainer to pass through the inner through hole and outer through hole, the inner rod being locked to the outer through hole; the inner rod in the outer tube can swing slightly in the receiving space of the outer tube; an outer side of the outer tube being formed with a scale and a recess; when the outer tube is received in the receiving space of the holding portion, the scale protrudes out of the holding portion for indicating the tension of the tension spanner suffered; and an inner sleeve, an outer sleeve, an elastic body and a supporting post are received in the receiving space of the outer tube; the supporting post being a round post; when the supporting post is received into the outer tube, the supporting post and the outer tube are totally received into the receiving hole of the holding portion; an outer surface of the supporting post has a block; the block being received in the recess of the outer tube and being slidable therein; when a force is applied to the holding portion so that the outer tube slides, the position of the block will make a number of the holding portion to align with the scale of the outer tube so as to know the tension applied; the upper edge of the outer sleeve having two concave recesses; the elastic body resists against a lower edge of the outer sleeve; the inner sleeve being received in the outer sleeve; the inner sleeve is a hollow cylinder with smooth outer surface; an upper edge of the inner sleeve being inclined; the roller being pivotally installed in the inner sleeve; and one end of the elastic body resisting against the bottom of the outer sleeve and another end thereof resists against an upper side of the supporting post so that the outer sleeve and the supporting post are retained with a predetermined distance; when a force is applied to the holding portion so that the holding portion displaces with respect to the outer tube, the elastic body will compress and the outer sleeve suffers from a resilient force from the elastic body; the force is transferred to an inner sleeve so that the roller will apply a force to the rolling ball.

The various objects and advantages of the present invention will be more readily understood from the following detailed description when read in conjunction with the appended drawing.

### BRIEF DESCRIPTION OF THE DRAWINGS

FIG. 1 shows an exploded perspective view of the tension spanner of the present invention.

FIG. 2 is a schematic cross sectional view of the tension spanner of the present invention.

FIG. 3 is a schematic view showing that the inner sleeve of the present invention has a sealed bottom end.

FIG. 4 is a schematic view showing that the inner sleeve of the present invention has an opened bottom end.

FIG. 5 is a schematic perspective view of the tension spanner of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

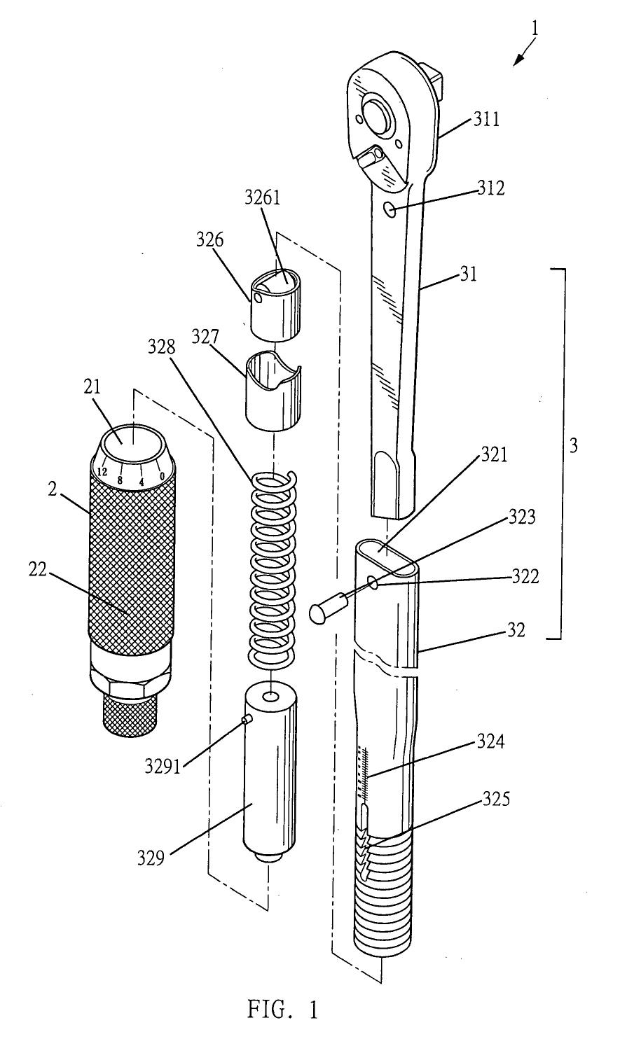

With referring to FIG. 1, the tension spanner 1 of the present invention is illustrated. The present invention has the following elements.

A holding portion 2 has an axial receiving hole 21 at one end thereof. An outer periphery of the holding portion 2 is formed with a plurality of textures 22 for being held steadily. An upper periphery of the holding portion 2 has a plurality of numbers for indicating the position in alignment (will be described hereinafter).

A handle 3 has an inner rod 31 and an outer tube 32. One upper end of the inner rod 31 has a head 311 for locking to an object. The inner rod 31 is formed with an inner through hole 312 near the head 311. Another end of the inner rod 31 is installed with an axial rolling ball 313. The outer tube 32 has a receiving space 321. One end of the outer tube 32 is received in the receiving hole 21 of the holding portion 2 and another end thereof receives the inner rod 31. An upper side of the outer tube 32 has an outer through hole 322. By using a retainer 323 to pass through the inner through hole 312 and outer through hole 322, the inner rod 31 is locked to the outer through hole 322. The inner rod 31 in the outer tube 32 can swing slightly in the receiving space 321 of the outer tube 32. An outer side of the outer tube 32 is formed with a scale 324 and a recess 325. When the outer tube 32 is received in the receiving space 321 of the holding portion 2, the scale 324 protrudes out of the holding portion 2 for indicating the tension of the tension spanner suffered.

An inner sleeve 326, an outer sleeve 327, an elastic body 328 and a supporting post 329 are received in the receiving space 321 of the outer tube 32.

The supporting post 329 is a round post. When the supporting post 329 is received into the outer tube 32, the supporting post 329 and the outer tube 32 are totally received into the receiving hole 21 of the holding portion 2. An outer surface of the supporting post 329 has a block 3291. The block 3291 is received in the recess 325 of the outer tube 32 and is slidable therein. When a force is applied to the holding portion 2 so that the outer tube 32 slides, the position of the block 3291 will make a number of the holding portion 2 to align with the scale 324 of the outer tube 32 so as to know the tension applied.

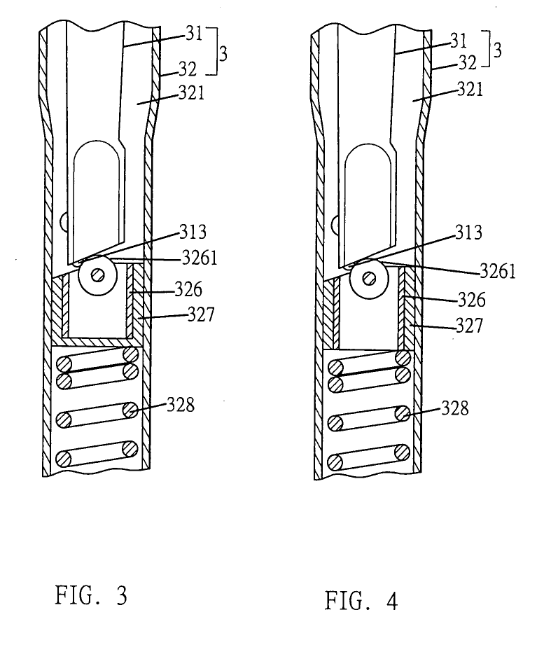

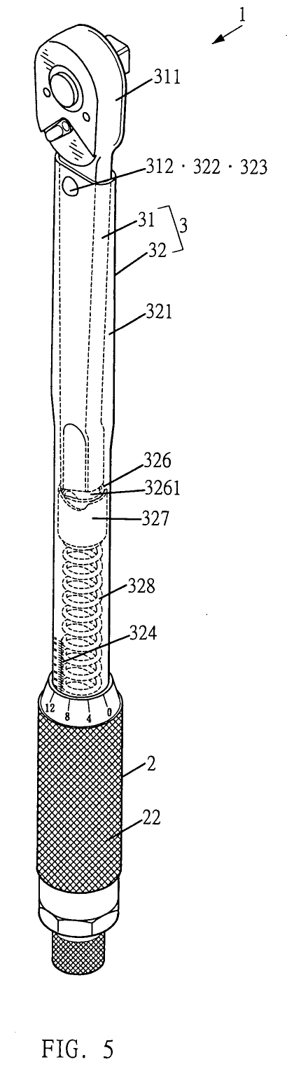

The outer sleeve 327 is a cup like post. The upper edge of the outer sleeve 327 has two concave recesses. Referring to FIG. 3, the outer sleeve 327 may be a solid bottom. At this case, the elastic body 328 resists against the bottom of the outer sleeve 327. Referring to FIG. 4, the bottom of outer sleeve 327 may be hollowed and the elastic body 328 passes through the bottom of the outer sleeve 327. The inner sleeve 326 is received in the outer sleeve 327. Preferably, the inner sleeve 326 is made of soft material, such as copper. The inner sleeve 326 is a hollow cylinder with smooth outer surface. An upper edge of the inner sleeve 326 is inclined. The roller 3261 is pivotally installed in the inner sleeve 326.

One end of the elastic body 328 resists against the bottom of the outer sleeve 327 and another end thereof resists against an upper side of the supporting post 329 so that the outer sleeve 327 and the supporting post 329 are retained with a predetermined distance. When a force is applied to the holding portion 2 so that the holding portion 2 displaces with respect to the outer tube 32, the elastic body 328 will compress and the outer sleeve 327 suffers from a resilient force from the elastic body 328. The force is transferred to the inner sleeve 326 so that the roller 3261 will apply a force to the rolling ball 313.

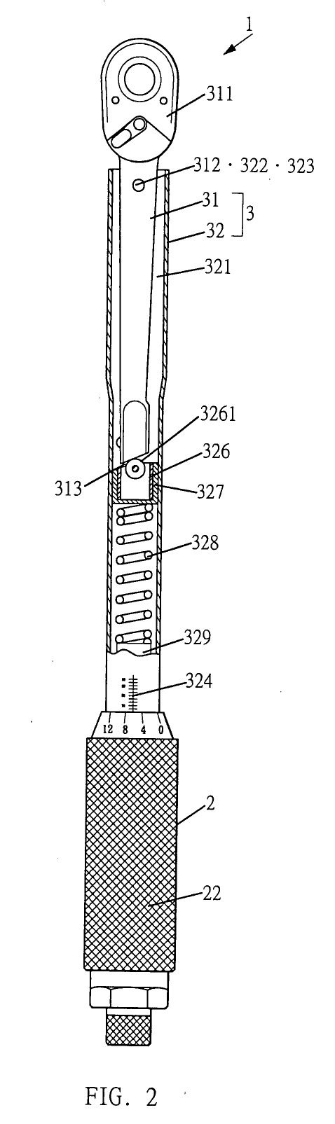

Referring to FIGS. 2 to 4, the assembly of the present invention is illustrated. In assembly, one end of the outer tube 32 is inserted into the receiving hole 21 of the holding portion 2. The supporting post 329 is placed into the receiving space 321 of the outer tube 32. Thus, the supporting post 329 and the outer tube 32 are received in the receiving hole 21 of the holding portion 2. The block 3291 is received in the recess 325 of the outer tube 32.

The elastic body 328 and the outer sleeve 327 are placed into the receiving space 321 of the outer tube 32. One end of the elastic body 328 resists against the supporting post 329 and another end of the elastic body 328 resists against the outer sleeve 327. By the elastic body 328, the outer sleeve 327 and the supporting post 329 retain with a predetermined distance. The inner sleeve 326 is placed into the outer sleeve 327. The roller 3261 of the inner sleeve 326 is at an upper side far away from the elastic body 328.

When the inner rod 31 is placed into the receiving space 321 of the outer tube 32, the retainer 323 retains in the inner through hole 312 of the inner rod 31 and the outer through hole 322 of the outer tube 32 so as to pivotally install the inner rod 31 to the outer tube 32. The inner rod 31 can swing slightly in the receiving space 321 of the outer tube 32. The rolling ball 313 of the inner rod 31 is in contact with the roller 3261 of the inner sleeve 326.

In use, a force is applied to the holding portion 2 and the outer tube 32 so that they move with respect to one another. The elastic body 328 is compressed. The force is transferred from the elastic body 328 to the outer sleeve 327 and then to the inner sleeve 326. The rolling ball 313 of the inner rod 31 tightly resists against the roller 3261 of the inner sleeve 326. Then the number aligned to the scale 324 is the tension applied.

When the tension spanner is used to drive an object engaged to the head 311, the head 311 has a react force. When the react force is not over a predetermined one, the inner rod 31 will swing to cause the roller 3261 separates from the rolling ball 313. The inner rod 31 will collide an inner wall of the outer tube 32 so as to alert the user that the applied force is over the preset value.

The inner sleeve 326 has smooth outer surface which is adhered to an inner surface of the outer sleeve 327. The inner sleeve 326 is made of soft material which is softer than the material of the inner sleeve 326. Not only the inner sleeve 326 is protected, when it slides in the outer tube 32, the outer sleeve 327 made of soft material will have slight deformation to reduce the wear and increase the stability. Thus, the lifetime of the tension spanner is prolonged.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A tension spanner comprising:
a holding portion having an axial receiving hole at one end thereof: an outer periphery of the holding portion being formed with a plurality of textures for being held steadily; an upper periphery of the holding portion having a plurality of numbers for indicating the position in alignment;
a handle having an inner rod and an outer tube; one upper end of the inner rod having a head for locking to an object; the inner rod being formed with an inner through hole near the head; another end of the inner rod being installed with an axial rolling ball; the outer tube having a receiving space; one end of the outer tube being received in the receiving hole of the holding portion and another end thereof receiving the inner rod; an upper side of the outer tube having an outer through hole; by using a retainer to pass through the inner through hole and outer through hole, the inner rod is locked to the outer through hole; the inner rod in the outer tube can swing slightly in the receiving space of the outer tube; an outer side of the outer tube bring formed with a scale and a recess; when the outer tube is received in the receiving space of the holding portion, the scale protrudes out of the holding portion for indicating the tension applied to the tension spanner; and
an inner sleeve, an outer sleeve, an elastic body and a supporting post being received in the receiving space of the outer tube;
the supporting post being a round post; when the supporting post is received into the outer tube, the supporting post and the outer tube are totally received in the receiving hole of the holding portion; an outer surface of the supporting post has a block; the block being received in the recess of the outer tube and being slideable therein; when a force is applied to the holding portion so that the outer tube slides relative to the holding portion, the position of the block will make a number on the holding portion align with the scale of the outer tube so as to know the tension applied;
the upper edge of the outer sleeve having two concave recesses; the elastic body resisting against a lower edge of the outer sleeve; the inner sleeve being received in the outer sleeve; the inner sleeve is a hollow cylinder with smooth outer surface; an upper edge of the inner sleeve being inclined; a roller being rotatably installed in the inner sleeve;
one end of the elastic body resisting against the bottom of the outer sleeve and another end thereof resisting against an upper side of the supporting post so that the outer sleeve and the supporting post are retained with a predetermined distance; when a force is applied to the holding portion so that the holding portion displace with respect to the outer tube, the elastic body will compress and the outer sleeve receives a resilient force from the elastic body; the force is transferred to an inner sleeve so that the roller will apply a force to the rolling ball.

2. The tension spanner as claimed in claim 1, wherein a material of the outer sleeve is softer than that of the inner sleeve.

3. The tension spanner as claimed in claim 2, wherein the outer sleeve is made of copper.

4. The tension spanner as claimed in claim 1, wherein the outer sleeve has a solid bottom; and the elastic body resists against the bottom of the outer sleeve.

5. The tension spanner as claimed in claim 1, wherein the bottom of outer sleeve is hollowed and the elastic body passes through the bottom of the outer sleeve.

6. The tension spanner as claimed in claim 4, wherein the outer sleeve is a cup like post and receives the inner sleeve.

7. The tension spanner as claimed in claim 1, wherein the outer sleeve is a hollow post and has a smooth outer surface.
